(19) United States
(12) Patent Application Publication
(10) Pub. No.: US 2025/0211924 A1
(43) Pub. Date: Jun. 26, 2025

(54) METHOD FOR OPERATING A HEARING AID

(71) Applicant: Widex A/S, Lynge (DK)

(72) Inventor: Jakob NIELSEN, Lynge (DK)

(73) Assignee: Widex A/S, Lynge (DK)

(21) Appl. No.: 18/844,668

(22) PCT Filed: Feb. 7, 2023
(86) PCT No.: PCT/EP2023/052893

§ 371 Date: Sep. 6, 2024

(30) Foreign Application Priority Data
Mar. 7, 2022 (DK) PA202200183

(51) Int. Cl. H04R 25/00; G10L 19/012

(52) U.S. Cl. CPC H04R 25/505; G10L 19/012; H04R 2225/41; H04R 2225/43

(57) ABSTRACT

A method for operating a hearing aid, in which, with a microphone, an overall audio signal is detected. A background signal is determined in the overall audio signal. An artificial noise is created depending on the background signal and added to the overall audio signal, and the overall audio signal is output by an output device. Also described is a hearing aid and a method for operating the hearing aid system.

The invention relates to a method for operating a hearing aid comprising a microphone and an output device. Furthermore, the invention relates to a hearing aid and a method for operating a hearing aid system comprising two hearing aids.

People suffering from hearing loss usually use a hearing aid device. In this case, an ambient sound is usually converted into an electrical (audio/sound) signal by means of a microphone, i.e., an electromechanical sound transducer, so that the electrical signal is detected. The detected electrical signals are processed by means of an amplifier circuit and introduced into the person's auditory canal by means of another electromechanical transducer in the form of a receiver. In most cases, processing of the detected sound signals also takes place, for which a signal processor of the amplifier circuit is usually used. In this case, the amplification is adjusted to any hearing loss of the hearing aid wearer.

If the ambient sound also contains sound from an interference source, also an unwanted source, this is also detected and, due to the amplification, introduced into the person's auditory canal in an amplified form. This makes it difficult for the person to identify the desired components in the sound emitted into the auditory canal. In order to avoid this, a directional microphone is usually used. Said directional microphone is set to a desired sound source, so that mainly the sound emitted by this is detected or at least processed by means of the electromechanical sound transducer. This part of the ambient sound is amplified and delivered to the auditory canal by the amplifier circuit. However, it still contains part of the sound emitted by the interference source, so that it is perceived by the person, even if it is not amplified, for example.

In this context, it is possible that the interference source emits information that can be understood by humans. In this case, the source of interference is, for example, a multimedia device such as a television or a radio, or uninvolved people talking to each other. If the person wearing the hearing aid is now having a conversation with a counterpart, words from the interference sources also enter the auditory canal, which makes it difficult for the person wearing the hearing aid to follow the conversation with the counterpart.

The invention is based on the task of specifying a particularly suitable method for operating a hearing aid as well as a particularly suitable hearing aid and a particularly suitable method for operating a hearing aid system, wherein in particular comfort is increased and/or following a conversation is facilitated.

With regard to the method for operating a hearing aid, this task is solved by the features of claim 1, with regard to the hearing aid by the features of claim 9, and with regard to the method for operating a hearing aid system by the features of claim 10 according to the invention. Advantageous further developments and embodiments are the subject of the respective dependent claims.

The method serves for the operation of a hearing aid. For example, the hearing aid is a headphone or comprises a headphone. Particularly preferably, however, the hearing aid is a hearing aid device. The hearing aid device serves for assisting a person suffering from a reduction in hearing ability. In other words, the hearing aid device is a medical device, by means of which, for example, a partial hearing loss is compensated. The hearing aid device is, for example, a behind-the-ear hearing aid device worn behind a pinna, a receiver-in-the-canal hearing aid device (RIC; ex-receiver-hearing aid device), an in-the-ear hearing aid device such as an in-the-ear hearing aid device, an in-the-canal hearing aid device (ITC) or a complete-in-canal hearing aid device (CIC), hearing glasses, a pocket hearing aid device, a bone conduction hearing aid device or an implant.

The hearing aid is provided and designed to be worn on the human body. In other words, the hearing aid preferably comprises a holding device, by means of which attachment to the human body is possible. If the hearing aid is a hearing aid device, the hearing aid is provided and designed to be placed, for example, behind the ear or within an auditory canal. In particular, the hearing aid is wireless and is provided and designed to be inserted at least partially into an auditory canal. Particularly preferably, the hearing aid comprises an energy storage device, by means of which an energy supply is provided.

The hearing aid further comprises a microphone for detecting sound. The microphone is expediently arranged at least partially within a housing of the hearing aid and thus at least partially protected. In particular, during operation by means of the microphone, an ambient sound, or at least a part thereof, is detected. In particular, the microphone is an electromechanical sound transducer. The microphone has, for example, only a single microphone unit or a plurality of microphone units interacting with each other. Each of the microphone units expediently has a diaphragm, which is set into oscillation by means of sound waves, wherein the oscillations are converted into an electrical signal by means of a corresponding capture device, such as a magnet, which is moved in a coil. Thus, by means of the respective microphone unit, it is possible to detect an audio signal based on the sound impinging on the microphone unit. The microphone units are designed to be unidirectional in particular.

Furthermore, the hearing aid has an output device for outputting an output signal. The output signal here is in particular an electrical signal. The output device is, for example, an implant or, particularly preferably, also an electromechanical sound transducer, preferably a loudspeaker, which is also referred to as an earpiece. Depending on the design of the hearing aid, in the intended state, the output device is at least partially arranged within an auditory canal of a wearer of the hearing aid, i.e. a person, or is at least acoustically connected to the latter.

According to the method, an ambient sound is measured or at least registered by means of the microphone and the electrical overall audio signal is generated on the basis of this. However, in the following the electrical overall audio signal may simply be denoted overall audio signal.

In a subsequent method step, a background signal is determined in the overall audio signal. Especially a level, e.g., a sound pressure level, of the background signal is determined thereby. Additionally, and in a similar manner a desired signal can be determined in the overall audio signal. The background signal is typically an unwanted audio signal, by means of which, for example, a desired portion of the overall audio signals at least partially masked or distorted. At the very least, the background signal is a signal that the wearer of the hearing aid, also referred to as the user, does not want to follow or listen to, and/or that distracts the user from the desired signal, if any. The background signal may be based on sound that is/was emitted by a source of interference and that meets the hearing aid. The background signal is therefore an interference signal. It is possible that the background signal corresponds to human speech, so that the source of interference is, for example, people talking or a media playback device, such as a radio or a television.

Depending on the background signal, an artificial noise is created. Consequently, the respective artificial noise differs for at least two different background signals. For example, different manifestations of the artificial noise are stored in a memory, and for the creation thereof, the artificial noise is retrieved from the memory. Preferably, however, the artificial noise is created by means of an algorithm, such as an MLS algorithm. The artificial noise may be so-called white noise that has a flat frequency spectrum (i.e. equal energy as a function of frequency. Alternatively, the artificial noise may be so-called pink noise where the amount of energy decreases with increasing frequency or may be grey noise that is random white noise subjected to a psychoacoustic equal loudness curve over a given range of frequencies, which gives the listener the perception that it is equally loud at all frequencies. However, the artificial noise may also be frequency shaped in various other way, e.g. by allowing at least one frequency range (e.g. a frequency band) of a white noise or pink noise signal to have an additional gain added, e.g. by filtering the white or pink noise signal or e.g. by providing a signal that comprises a plurality of frequency band signals (or frequency ranges) that each comprises white noise or pink noise and wherein said plurality of frequency band signals may have different added gains applied to them. The frequency shaping may be advantageous in enabling a constant difference between the (average of) sound pressure level of the artificial noise compared to the background signal.

The artificial noise is added to the overall audio signal Preferably the artificial noise is added to the processed overall audio signal, i.e. the hearing loss compensated and typically noise suppressed overall audio signal. Thus, the processed overall audio signal comprising the artificial noise, is output by means of the output device, so that it can be perceived by the wearer of the hearing aid. For example, by means of the output device the overall audio signal is converted into sound or electrical pulses are provided. Preferably, before putting out the overall audio signal a sound pressure of the overall audio signal or another value corresponding to the volume of the overall audio signal is determined. If one of those is greater than a respective limit, the sound pressure/volume of the overall audio signal is reduced, especially uniformly. Thereby, a damage to the wearer of the hearing aid is prevented.

Thus according to the method, the wearer of the hearing aid is presented not only with the processed overall audio signal, but also with the artificial noise whereby the background signal is at least partially covered and/or masked, so that it is only perceptible by the wearer of the hearing aid to a reduced extent. For the wearer of the hearing aid, the artificial noise is comparatively easy to block out psychoacoustically, for which reason the intelligibility and/or clarity of other components of the overall audio signal is improved. In other words, the wearer blocks out the artificial noise by habituating to it. Thus, it is easier for the wearer of the hearing aid to follow a conversation contained in the overall audio signal, whereby the user may experience that comfort is increased due to less strained mental resources. Additionally, comparatively complex processing of the detected overall audio signal may not be required, which reduces hardware requirements for the hearing aid. According to the method, the artificial noise is preferably at least one of more stationary compared to a stationarity threshold representing the stationarity of a predetermined average background signal and less modulated compared to a modulation threshold representing the modulation of a predetermined average background signal. In other words, the artificial noise is a high stationarity signal or a low modulation signal. Examples of a high stationarity or low modulation signal are a white noise signal, a pink noise signal, a grey noise signal, a frequency shaped white noise signal or a frequency shaped pink noise signal, wherein the frequency shaping may be provided by a single frequency filter or by dividing the white or pink noise signals into frequency bands (i.e. separate frequency ranges) and allowing different gains to be applied to the frequency bands.

The method used to determine the stationarity or modulation of a signal is preferably based on the fluctuations of the envelope of the signal. The considered modulation rate may be in the range of say 1 Hz to 70 Hz, and the amplitude modulation depth is typically measured in dB. By applying an artificial noise according to the invention the amplitude modulation of the considered modulation rate range is reduced suitably for the combination of the background signal and the artificial noise. The depth of the amplitude modulations may be measured using a moving average of the time domain signal. Preferably an exponential moving average with a time constant is used. Expediently, the time constant is between 1 milliseconds (which in the following may be abbreviated: ms) and 50 ms or between 5 ms and 20 ms. For example, the time constant may be around 10 ms. Alternatively, or in combination therewith spectral methods are applied. For these methods the same range of modulation rates are considered. As one example the amplitude modulation depth can be determined based on the difference between a 10% and a 90% percentile, wherein the percentiles may be determined over a time window in the range between 10 seconds and 10 minutes and with an update speed in the range between 1 Hz and 20 Hz.

The specific characteristics of the artificial noise may be permanently stored in the hearing aid, for example, by the manufacturer of the hearing aid or by an audiologist by means of whom the hearing aid is adjusted. Alternatively, the dependency can be adjusted, by the user, i.e. the wearer of the hearing aid. Alternatively, or in combination therewith, the sound pressure level of the artificial noise is adjustable, for example, on the part of the user. In this case, for example, the artificial noise is first created depending on the background signal, whereby a specific sound pressure level is selected. Subsequently, it is possible for the user to make a fine adjustment of the settings. According to one example the user may prefer that the sound pressure level of the low frequency part of the artificial noise signal is increased relative to the high frequency part or vice versa. According to another example the sound pressure level of the artificial noise relative to the sound pressure level of the background signal can be adjusted by the user, e.g. in steps of +/−1 dB within a range of +/−6 dB Finally, it may be that at least one of the frequency resolution and the allowed difference in dB of the frequency shaping can be adjusted by the user.

Preferably, the overall audio signal is additionally processed, wherein, for example, certain components of the overall audio signal are amplified. Alternatively, or in combination therewith, the overall audio signal is filtered and/or compressed. In particular, the processing of the overall audio signal is performed in such a way that any hearing loss of the wearer of the hearing aid is at least partially compensated. Alternatively, or in combination therewith, a noise reduction is carried out, for which preferably a corresponding algorithm is used. For example, the background signal is determined directly after detection of the microphone or at certain stages of the processing of the overall audio signal. However, preferably the determination of the background signal or at least the addition of the artificial noise to the overall audio signal takes place after the other processing of the overall audio signal has been completed. Thus, if by means of an algorithm processing the overall audio signal e.g. the background signal is removed or suppressed below the hearing threshold of the user then an artificial noise signal need not be added. Also, the artificial noise is not removed, for example at least partially, from the overall audio signal due to an algorithm processing the overall audio signal. In summary, the addition of the artificial noise preferably represents the last step before the resulting signal is output by means of the output device.

For example, the overall audio signal is an omnidirectional audio signal, and the microphone has, for example, only a single microphone unit. Particularly preferably, however, the microphone comprises a plurality of microphone units, and the microphone is at least partially designed as a directional microphone.

For example, the sound pressure level of the artificial noise is selected to be less than or equal to the sound pressure level of the background signal. This means that the background signal is still at least partially perceptible to the wearer of the hearing aid, so that the wearer could, for example, follow a possible further conversation if he or she wanted to. Thus, it is also ensured that the artificial noise is not likely to be consciously perceived. Particularly preferably, however, the sound pressure level of the artificial noise is selected to be greater than the sound pressure level of the background signal, Whereby, the background signal most likely is not perceptible, for the wearer of the hearing aid, due to the masking provided by the artificial noise. Preferably, the artificial noise is created in such a way, that the difference between the sound pressure level of the artificial noise and the sound pressure level of the background signal, e.g. measured as time average of the background signal, is at most 10 dB, 5 dB or 2 dB. Hereby, the sound pressure level of the artificial noise is greater than the sound pressure level of the background signal or the other way around. Due to the limited difference, the artificial noise is relatively easy to get habituated to for the wearer of the hearing aid. Because the artificial noise at least partly masks the background signal, the disturbing effect from the background signal is reduced, which increases the speech intelligibility or intelligibility of the remaining components contained in the overall audio signal.

According to an embodiment a desired signal is determined in the overall audio signal. For example, the desired signal is directly in the overall audio signal or is at least partially created based on processing of the overall audio signal, e.g. using binaural beamforming capable of separating the background signal and the desired signal, e.g. by defining the desired signal as the sound coming from at least a part of the front half sphere and by defining the background signal as the sound coming from at least a part of the back half sphere. The desired signal may contain human speech, such as a conversation, that the wearer of the hearing aid wishes to follow. Typically, the desired signal originates from a region of space in the direction of view of the wearer of the hearing aid. The sound pressure level of the artificial noise is chosen to be smaller than the sound pressure level of the desired signal, in particular by at least 3 dB, 5 dB, 6 dB or 10 dB. In this way, the desired signal is not masked by the artificial noise, so that the wearer of the hearing aid can listen to the desired signal essentially undisturbed. Due to the mentioned values, an effort for the wearer of the hearing aid to follow the desired signal is comparatively low in this case. Consequently, comfort is increased. Preferably, the sound pressure level of the artificial noise is selected to be higher than the sound pressure level of the background signal. Thus, a clarity of the desired signal is comparatively strongly increased.

According to an embodiment, the signal-to-noise ratio of the overall audio signal is determined using a time average of the desired signal and a time average of the background signal, wherein the time constant used to determine the time average is preferably between 1 milliseconds and 2 seconds, between 10 ms and 1.5 seconds or between 100 ms and 1 second. Hereby, the signal-to-noise ratio of the overall audio signal is essentially constant, even if there are short breaks in the desired signal which e.g. is the case if the desired signal corresponds to human voice/conversation.

According to an embodiment the artificial noise is not added if the signal-to-noise ratio of the overall audio signal is higher than 15 dB or lower than 3 dB. According to a more specific embodiment this criteria is governed by a hysteresis, e.g. by providing that if the value of the signal-to-noise ratio changes to a value outside this given range whereby the artificial noise is not added, then the signal-to-noise ratio needs to change to a value within a more narrow range than the 3 dB to 15 dB range say between 5 dB and 13 dB, in order to return to adding the artificial noise and return to the previous range with respect to determining when not to add the artificial noise, whereby too frequent switching on and off of the artificial noise is avoided.

Thus according to an embodiment the algorithm for controlling whether to activate or de-activate the artificial noise is implemented as a state machine, whereby criterias other than the hysteresis example given above can be used to determine whether the artificial noise is to be added and if so at what sound pressure level.

According to another specific embodiment it may be decided whether to add the artificial noise based on a currently selected hearing aid program that may have been actively selected by the user or automatically selected by a classifier comprised in the hearing aid.

According to another embodiment the artificial noise is given a sound pressure level lower than the background signal level if the signal-to-noise ratio of the overall audio signal is lower than 3 dB.

According to an embodiment, the sound pressure level of the artificial noise is only set once, for example depending on a current listening situation. Preferably, however, the sound pressure level of the artificial noise is adjusted continuously and automatically. This ensures that the sound pressure level of the artificial noise is changed when the background signal changes. Preferably, the adjustment takes place at discrete points in time. For example, the background signal is determined again every 0.5 seconds, every second or every 2 seconds and the sound pressure level of the artificial noise is adjusted accordingly. Until the background signal is determined again and the artificial is adjusted again, the previous setting for the artificial noise is used. In this way, hardware requirements for the invention are reduced.

According to an embodiment, the artificial noise is adjusted substantially abruptly when the background signal is changed. Particularly preferably, however, a speed of change of the artificial noise setting, i.e. in particular its sound pressure level, is limited. In this case, in particular, the speed of change in the sound pressure level is limited, preferably to below 1 dB/s, 0.8 dB/s or below 0.5 dB/s or even 0.1 dB/s. Thus, for the wearer of the hearing aid, the change in artificial noise is essentially not consciously perceptible, so that the wearer also blocks out the changed noise and consequently does not perceive it. Consequently, comfort is increased, and the wearer of the hearing aid will in particular follow the desired signal and is not distracted by the change of the artificial noise, and furthermore the background signal is also at least partially covered/masked.

According to an embodiment, a default value is used for the artificial noise when the hearing aid is turned on, which is subsequently adjusted to the determined background signal. Thus, already after switching on the hearing aid, the background signal is at least partially masked, so that comfort is further increased. Alternatively, after switching on the hearing aid, initially no noise is created, or this has a sound pressure level of 0 dB. Only subsequently, the sound pressure level of the noise is adjusted depending on the background signal, wherein the speed of change is expediently limited. In this way, the presence of the noise is also not consciously perceptible to the wearer of the hearing aid, so that comfort is further increased.

According to an embodiment, the sound pressure level of the artificial noise is constant over all frequencies, and as such the artificial noise is a white noise signal. Particularly preferably, however, the artificial noise is created in a frequency-selective manner. In other words, a different sound pressure level of the artificial noise is used for different frequencies. Particularly preferably, the overall audio signal or at least the background signal is divided into different frequency bands, wherein each of the frequency bands has a width between 0.2 and 0.5 of an octave, and particularly one third of an octave. If an adjustment of the noise is effected, this is expediently carried out separately for the different frequency bands. Preferably, the speed change of the noise is limited in this case, with a corresponding limitation for each frequency band. In particular, the artificial noise is generated in such a way that a distance between the sound pressure levels of the artificial noise assigned to the individual frequency bands/frequencies is smaller than a certain limit value. The limit value is, for example, 10 dB, 8 dB or expediently 6 dB. In this way, the noise is essentially perceived as uniform to the wearer of the hearing aid, while the sound pressure level of the noise is nevertheless as low as possible.

According to an embodiment, the background signal is identified by an algorithm. Alternatively, or in combination therewith, the part of the overall audio signal that is assigned to a specific spatial area around the hearing aid is used as the background signal. Particularly preferably, a percentile of the overall audio signal, in particular its sound pressure level, is used as the background signal. In this way, the background signal can be determined with comparatively little effort. For example, the percentile used is between the 15% percentile and the 5% percentile, between the 12% percentile and the 8% percentile, and especially preferably equal to the 10% percentile. In other words, the 10% percentile of the overall audio signal is used as the background signal. In this way, those components of the overall audio signal, which already have a comparatively low sound pressure level are masked by means of the artificial noise because the sound pressure level of the artificial noise and the background signal are not too far apart as already described above.

Thus, using a background signal level estimation based on e.g. percentiles it is ensured that further signals, which are present in the overall audio signal in addition to the background signal and the possible desired signal are not masked. For example, a warning signal that is generated, for example, by a device such as a siren or horn, or by a human being, and that has a comparatively high sound pressure level, is not masked by means of the artificial noise, even if this is not the desired signal. Additionally, if there is no desired signal in the overall audio signal, for example, especially if the wearer of the hearing aid is in a room where people are talking but not with the wearer of the hearing aid, a distance between the 10% percentile and, for example, the 90% percentile is comparatively small. Since the artificial noise is created depending on the 10% percentile, the rest of the overall audio signal in this case is also difficult to perceive for the wearer of the hearing aid, so that the wearer can remain undisturbed or at least comfortable in the room. However, when a conversation is directed to the hearing aid wearer, the distance between the 90% percentile and the 10% percentile is increased, so that the hearing aid wearer can follow the conversation. Thus, there is no need for case discrimination or the like, or for special adaptation of the method to particular listening situations, for which reason the method is comparatively robust.

The hearing aid has a microphone, an output device and a signal processing unit. By means of these, in particular, a signal path is formed, and the microphone is preferably for detecting sound and the output device is suitably for outputting sound. For example, the hearing aid is a headphone or comprises a headphone.

In this case, for example, the hearing aid is designed as a so-called headset. Particularly preferably, however, the hearing aid is a hearing aid device. The hearing aid device serves to support a person suffering from a reduction in hearing ability. In other words, the hearing aid is a medical device, by means of which, for example, a partial hearing loss is compensated. The hearing aid device is, for example, a behind-the-ear hearing aid device (BTE) worn behind a pinna a receiver-in-the-canal hearing aid device (RIC; ex-receiver-hearing aid device), an in-the-ear hearing aid device such as an in-the-ear hearing aid device, an in-the-canal hearing aid device (ITC) or a complete-in-canal hearing aid device (CIC), hearing glasses, a pocket hearing aid device, a bone conduction hearing aid device or an implant. Particularly preferably, the hearing aid device is.

The hearing aid is operated according to a method, in which an overall audio signal is detected by means of the microphone. A background signal is determined in the overall audio signal. An artificial noise is generated depending on the background signal and added to the overall audio signal. The overall audio signal is output by means of an output device. For example, the determining, creating and/or adding is effected by means of the signal processing unit. In other words, the signal processing unit is suitable, in particular provided and designed to carry out the method at least partially or completely.

Expediently, the hearing aid expediently comprises a signal processor, which suitably forms the signal processing unit or is at least a component thereof. The signal processor is for example a digital signal processor (DSP) or realized by means of analog components. By means of the signal processor, in particular, an adaptation of the overall audio signal is also effected, preferably depending on any hearing loss of a wearer of the hearing aid. Expediently, an A/D converter is arranged between the microphone and the signal processing unit, for example the signal processor, if the signal processor is designed as a digital signal processor. The signal processor is set in particular depending on a parameter set. By means of the parameter set, an amplification in different frequency ranges is specified, so that the overall audio signal is processed according to certain specifications, in particular depending on a hearing loss of the wearer of the hearing aid. Particularly preferably, the hearing aid additionally comprises an amplifier, or the amplifier is at least partially formed by means of the signal processor. For example, the amplifier is connected upstream or downstream of the signal processor in terms of signal technology.

The other method serves for operating a hearing aid system, which has two such hearing aids, and which is thus of binaural design. Thus, according to the method for operating the hearing aid system, each of the hearing aids is respectively operated according to the above-mentioned method. Thus, in each of the hearing aids, an artificial noise is created depending on the respective background signal and added to the respective overall audio signal, which is output by means of the output device of the respective hearing aid. It is additionally provided that the sound pressure level of the artificial noise at the two hearing aids is matched to each other. In other words, for example, the sound pressure level of the artificial noise at one of the hearing aids is additionally matched depending on the sound pressure level of the artificial noise created at the other hearing aid. Alternatively, the sound pressure level for the artificial noise at both hearing aids is first determined separately, and based on the two sound pressure levels, a respective sound pressure level for the artificial noise at both hearing aids is created, which is then added to the respective overall audio signal.

For example, the sound pressure level of the artificial noise emitted by the two hearing aids differs, so that in one of the hearing aids, for example, the artificial noise is less perceptible compared to the other. For example, a current situation of the wearer of the hearing aid is also taken into account, such that e.g. the sound pressure level of the artificial noise is selected to be comparatively low for the hearing aid on whose side the sound pressure level of the ambient sound is likewise low. For example, head movement is also taken into account, so that for the wearer of the hearing aid system the direction, from which the noise originates for him is always the same.

However, according to an embodiment the sound pressure level of the artificial noise is selected to be the same for both hearing aids. In particular, the sound pressure level of the respective artificial noise is first determined separately by means of the two hearing aids, and then the two are compared with each other. Since the sound pressure level of the artificial noise of both hearing aids is chosen to be the same, the wearer of the hearing aid is not falsely given a spatial impression, which has the effect that comfort is increased. According to an embodiment, the lower of the two values for the sound pressure level of the artificial noise is used for the artificial noise generated by both hearing aids. Thus, the artificial noise is only comparatively less perceptible by the wearer of the hearing aid. Preferably, however, the higher of the two values is used as the sound pressure level for the artificial noise in both hearing aids. Thus, the background signal in one of the hearing aids, is relatively less perceptible to the wearer of the hearing aid system, whereby comfort is increased.

Furthermore, the invention relates to a hearing aid system, operated according to the method for operating a hearing aid system.

The further developments and advantages described in connection with the methods are to be applied analogously to the hearing aid as well as the hearing aid system and to each other and vice versa.

In the following, embodiments of the invention are explained in more detail with reference to a figure. The figures show:

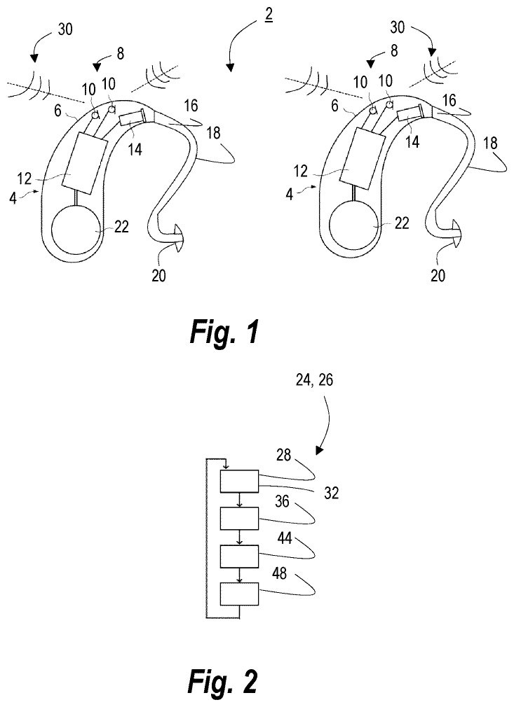

FIG. 1 schematically a hearing aid system with two identical hearing aids,

FIG. 2 a method for operating the hearing aid system,

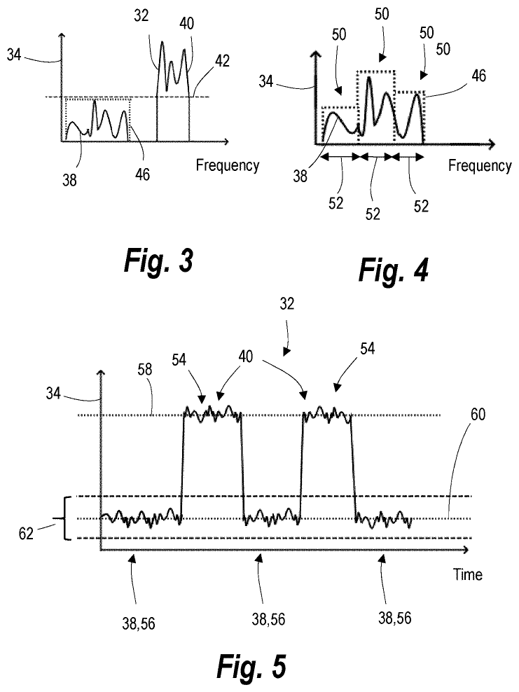

FIG. 3 a simplified illustration of an overall audio signal with a background signal and an artificial noise,

FIG. 4 a simplified illustration of an alternative form of the artificial noise, and

FIG. 5 a time series of the overall audio signal.

Corresponding parts are marked with the same reference signs in all figures.

FIG. 1 shows a hearing aid system 2 with two hearing aids 4 of identical design. Thus, the hearing aid system 2 is binaural. Each hearing aid 4 is designed as a hearing aid device provided and designed to be worn behind an ear of a user, which may also be denoted wearer or hearing aid wearer. In other words, it is a behind-the-ear hearing aid device. Each hearing aid 4 comprises a housing 6, which is made of a plastic material. Within the respective housing 6, a microphone 8 with two microphone units 10 in the form of respective electromechanical transducers is arranged, which are designed omnidirectionally. By changing a time offset between the acoustic signals detected by means of the omnidirectional microphone units 10, it is possible to change a directional characteristic of the microphone 8, so that a directional microphone is realized. The two microphone units 10 are signal-coupled to a signal processing unit 12, which comprises an amplifier circuit not shown in more detail and a signal processor. The signal processing unit 12 is furthermore formed by means of circuit elements, such as electrical and/or electronic components. The signal processor is a digital signal processor (DSP) and is signal-coupled to the microphone units 10 via an A/D converter, which is not shown in more detail.

An output device 14 in the form of a receiver is signal-coupled to the signal processing unit 12. By means of the output device 14, which is thus an electromechanical sound transducer, an (electrical) signal provided by the signal processing unit 12 is converted into an output sound 16 during operation, i.e. into sound waves. These sound waves are introduced into a sound tube 18, one end of which is attached to the housing 6. The other end of the sound tube 18 is enclosed by means of a dome 20, which, in the intended state, is arranged in an auditory canal of the user, i.e. the wearer of the two hearing aids 4, which is not shown in more detail here. The dome 20 has a plurality of openings, so that wearing comfort is increased. The power supply of the signal processing unit 12, the microphone 8 as well as the output device 14 is effected by means of a battery 22 arranged in the respective housing 6. Additionally, each of the hearing aids 4 has a communication device, not shown in more detail, by means of which communication between the two hearing aids 4 is made possible.

However, as will be well known for the skilled person, hearing aid systems exists in many different forms and one specific advantage of the present invention is that it can be implemented in any type and variation of hearing aid and consequently, just to name a few specific examples, the present invention is independent on whether it is implemented in a monaural hearing aid or in a binaural hearing aid system. It is also independent on whether the hearing aid is of the behind-the-ear type or any of the other hearing aid types mentioned above and independent on whether the hearing aid housing is made of plastic or e.g. some metal such as titanium.

One specific advantageous aspect of the present invention resides in the fact that the invention can be implemented independent on, whether-and if so, the type of directional system comprised in the hearing aid or binaural hearing aid system. Thus the directional system may be based on monaural beam forming or binaural beam forming or a combination of the two (e.g. based on monaural beam formed signals being the input signals to a binaural beam former).

FIG. 2 illustrates a method 24 for operating the hearing aid system 2. According to said method 24, each of the hearing aids 4 is operated according to a method 26 for operating a hearing aid 4. Consequently, the method 26 for operating the hearing aid is carried out for each of the hearing aids 4, for which purpose the respective signal processing unit 12 is used at least partially.

In a first method step 28, an ambient sound 30 is registered at the respective hearing aid 4 by means of the respective microphone 8 and an overall audio signal 32 is created on the basis of this. In other words, the ambient sound 30 is converted into the electrical overall audio signal 32 which in the following for convenience may simply be denoted overall audio signal. FIG. 3 shows the sound pressure level 34 versus the frequency of the overall audio signal 32. In this case, the solid line represents the overall audio signal 32 detected by the microphone 8.

In a subsequent second method step 36, a background signal 38 and a desired signal 40 are determined in the overall audio signal 32 by means of the respective signal processing unit 12. The sound pressure level 34 of the desired signal 40 is above a limit 42, and all components of the overall audio signal 32, whose sound pressure level 34 is below the limit 42, represent the background signal 38. In this case, the limit 42 is selected in such a way that the 10% percentile of the overall audio signal 32 represents the background signal 38. In other words, the 10% percentile of the overall audio signal 32 is used as the background signal 38. The desired signal 40 and also the background signal 38 are adjusted by means of the signal processing unit 12 according to a hearing loss of the wearer of the hearing aid system 2, but this is not shown here. However, according to another embodiment the limit 42 need not be used.

In a subsequent third method step 44, an artificial noise 46 is generated for each hearing aid 4 by means of the respective signal processing unit 12. The artificial noise signal is shown dotted in FIG. 3. The artificial noise 46 is created by means of an algorithm, such as a random generator, whereby the artificial noise 46 can be e.g. white noise (or at least the artificial noise has a flat frequency spectrum within at least one frequency range that comprises a background signal with a sound pressure level above the hearing threshold of the user). Alternatively, the artificial noise 46 is pink noise or the artificial noise 46 is created in some other frequency-selective manner such that the resulting artificial noise can generally be arbitrarily frequency shaped. It is noted that according to this specific embodiment the artificial noise only covers a part of the frequency range that is covered by the hearing aid system.

The respective sound pressure level 34 of the artificial noise 46 created by means of each of the hearing aids 4 as well as the associated frequencies are exchanged between the two hearing aids 4 by means of the communication device comprised in each of the two hearing aids 4. Subsequently, for each of the two hearing aids 4, the higher of the two sound pressure levels 34 is used for the respective associated artificial noise 46, so that, if necessary, the sound pressure level 34 of the artificial noise 46 is increased for one of the hearing aids 4. Also, if necessary, the respective artificial noise 46 is extended by those frequencies that are covered by the artificial noise 46 in the respective other hearing aid 4. Consequently the artificial noise 46 is the same for both hearing aids 4 and the sound pressure level 34 of the artificial noise 46 may be selected to be greater than the background signal 38 in both hearing aids 4. In summary, the sound pressure level 34 of the artificial noise 46 in both hearing aids 4 is matched to each other, namely equalized. According to an embodiment the equalization is carried out based on the sound pressure level measured in dB HL, such that a possible difference in hearing loss for the two ears is also taken into account.

However, this may not always be preferred. E.g. for persons having a highly asynchronous hearing loss it may instead be preferred to carry out the matching between the two ears as part of initial individualized hearing aid fitting or as part of a user fine tuning wherein the user determines best matching based on his or hers perceived sound pressure level of the artificial noise from both hearing aids.

The respective artificial noise 46 is added to the respective overall audio signal 32, so that the respective overall audio signal 32 now comprises the portion shown in FIG. 3 with the solid line and the portion shown with the dotted line.

However, it is noted that in another embodiment the equalization between the hearing aids 4 is not carried out at all and according to yet another embodiment the equalization is carried out without taken a possible difference in hearing loss into account despite that this is less preferred, but it is noted that for most people the hearing loss on the left and right side is similar and consequently it may be decided to realize a hearing aid where the possible difference in hearing loss between the two ears need not be taken into account.

In a subsequent fourth method step 48, the overall audio signal 32 comprising the artificial noise 46 is output by means of the respective output device 14, so that the respective output sound 16 is created, which is output into the respectively assigned ear of the wearer of the hearing aid system 2. In this case, the component of the output sound 16 corresponding to the desired signal 40 can be perceived by the wearer substantially undisturbed or adapted to his hearing loss, wherein this differs or at least can differ between the two hearing aid systems 4. The component of the output sound corresponding to the background signal 38, on the other hand, is less perceptible for the wearer of the hearing aid system 2, since it is masked by means of the output sound 16 corresponding to the artificial noise 46. The component of the output sound 16 corresponding to the artificial noise 46 can be comparatively easily masked out by the wearer of the hearing aid system 2 through habituation, so that the intelligibility of the component of the output sound 16 corresponding to the desired signal 40 is increased. Since the perception of the artificial noise 46 preferably does not differ between the two hearing aids 4 (due to the matching of the artificial noise), the output sound 16 does not create a false spatial impression. Furthermore, the matching of the artificial noise between the two hearing aids 4 provides that the resulting (i.e. combined) artificial noise is specifically well suited to be masked out through habituation.

After a certain period of time has elapsed, for example each 0.5 seconds or 1 second, the first through fourth method steps 28, 36, 44, 48 are repeated. In other words, the sound pressure level 34 of the artificial noise 46 is continuously (and automatically) updated and adjusted if required.

If the sound pressure level 34 of the background signal 38 increases in the process, the sound pressure level 34 of the artificial noise 46 is also increased. If the sound pressure level 34 of the background signal 38 decreases, the sound pressure level 34 of the artificial noise 46 is reduced. In this case, a speed of change of the artificial noise 46, namely the sound pressure level 34, is limited, and 0.5 dB/s is taken as a maximum change. Thus, the change of the artificial noise 46 is not consciously perceived by the wearer of the hearing aid system 2, and the wearer can concentrate undisturbed on the component of the output sound 16 corresponding to the desired signal 40.

After putting the hearing aid system 2 into operation, the method 24 and therefore also the method 26 is carried out, for example, always or only in certain listening situations. When this is started, for example after the first determination of the background signal 38, the sound pressure level 34 of the artificial noise 46 is set to e.g. a value that it is greater than the sound pressure level 34 of the background signal 38. In an alternative, the sound pressure level 34 is initially set at a lower or the same level as the background signal: In any case the artificial noise is adjusted by means of repeated execution of the first to fourth method steps 28, 36, 44, 48. Also the speed of change of the sound pressure level 34 of the artificial noise 46 is limited. Thus, for the wearer of the hearing aid system 2, the component of the output sound 16 corresponding to the artificial noise 46 is not likely perceptible at all, which further increases comfort.

FIG. 4 illustrates the artificial noise 46 and the background signal 38 according to an embodiment, wherein the background signal 38, based on which the artificial noise 46 is created, is not changed compared to FIG. 3. In other words, the circumstances wherein the method 26 is executed is the same. However, according to this embodiment, the spectrum of the background signal 38 is divided into different frequency bands 50, each of which has a constant width 52. The width 52 of each frequency band 50 corresponds to one third of an octave.

In each of the frequency bands 50, a different sound pressure level 34 of the artificial noise 46 is selected, whereby the artificial noise 46 is created in a frequency shaped manner. In this case, the sound pressure level 34 of the artificial noise 46 in each of the frequency bands 50 is selected to be 2 dB greater than the background signal 38 in the respective frequency band 50. Additionally, it is ensured that the sound pressure levels 34 of the artificial noise 46 associated with the different frequency bands 50 do not differ by more than 6 dB. Thus, it is possible that the sound pressure level 34 of the artificial noise 46 in one of the frequency bands 50 is greater than the sound pressure level 34 of the background signal 38, in the same frequency band, by more than 2 dB, but according to this embodiment, that is considered acceptable due to the advantage gained with respect to habituation by having an artificial noise signal with a relatively flat frequency spectrum.

Thus, compared to the FIG. 3 embodiment the sound pressure level 34 of the artificial noise 46 is at least partially reduced, but the component of the output sound 16 corresponding to the background signal 38 is nevertheless not likely to be perceptible to the wearer of the hearing aid system 2. If the background signal 38 changes in this case, the sound pressure level 34 of the artificial noise 46 is changed individually for each of the frequency bands 50. The speed of the change of the sound pressure level 34 of the artificial noise 46 for each of the frequency bands 50 is limited to 0.5 dB/s in this case as well.

In a further development, the desired signal 40 is also divided among the frequency bands 50, which is provided at least by means of an A/D converter arranged between the microphone 8 and the signal processing unit 12. Due to the division into frequency bands 50, at least some parts of the processing required for the present invention may be simplified.

FIG. 5 illustrates an example of the time series of an overall audio signal 32. The overall audio signal 32 comprises the desired signal 40 that corresponds to human conversation. Therefore, between time ranges 54 during which the desired signal 40 is dominant (and of those two are shown) there are several other time ranges 56, where the background signal 38 is dominant.

However, it is noted that dependent on how the desired signal and the background signal are defined these signals may co-exist. As one example this is the case if say the 90% percentile of the overall audio signal is used to represent the desired signal and say the 10% percentile of the overall audio signal is used to represent the background signal. Thus in this case the signal-to-noise ratio of the overall audio signal 32 can be determined based on the 10% percentile and the 90% percentile.

Anyway, based on the desired signal 40, i.e., the part of the overall audio signal 32 of the time ranges 54, a first time average 58 is determined. In a similar way, based on the background signal 38, i.e., the part of the overall audio signal 32 of the other time ranges 56, a second time average 60 is determined. Based on the two time averages 58, 60 the signal-to-noise ratio of the overall audio signal 32 can be determined.

The sound pressure level 34 of the artificial noise 46, which isn't shown, is in a level range 62 around the second time average 60. The upper limit of the level range 62 is 10 dB above the second time average 60. The lower limit of the level range 62 is 10 dB below the second time average 60. Therefore, the artificial noise 46 is created in such a way, that the difference between the sound pressure level 34 of the artificial noise 46 (or a time average of it) and the sound pressure level 34 of the background signal 38, (or alternatively the second time average 60), is at most 10 dB. If the signal-to-noise ratio is greater than 15 dB or smaller than 3 dB the creation of the artificial noise 46 will be stopped or at least won't be added to the overall audio signal 32.

One example of such time averages is a percentile: Thus the second time average 60 may be determined as a percentile in the range between the 5% and 15% percentile.

According to other embodiments at least one of the upper and lower limits of the level range 62 is reduced to be only 5 dB or 2 dB above or below the second time average 60 respectively. According to one specific embodiment only the lower limit of the level range is reduced to be only 5 dB or 2 dB below the second time average 60.

The invention is not limited to the embodiments described above. Rather, other variants of the invention can also be derived therefrom by the expert without leaving the object of the invention. Furthermore, in particular, all individual features described in connection with the individual embodiment examples can also be combined with each other in other ways without leaving the object of the invention

### List of Reference Signs

2 hearing aid system
4 hearing aid
6 housing
8 microphone
10 microphone unit
12 signal processing unit
14 output device
16 output sound
18 sound tube
20 dome
22 battery
24 method for operating a hearing aid system
26 method for operating a hearing aid
28 first method step
30 ambient sound
32 overall audio signal
34 sound pressure level
36 second method step
38 background signal
40 desired signal
42 limit
44 third method step
46 artificial noise
48 fourth method step
50 frequency band
52 width
54 time range of the desired signal
56 other time range
58 first time average
60 second time average
62 level range

1. A method for operating a hearing aid, wherein
an overall audio signal is detected by means of a microphone,
a background signal is determined from the overall audio signal,
an artificial noise is created based on the background signal and added to the overall audio signal, and
the overall audio signal is output by means of an output device.

2. The method according to claim 1, wherein the artificial noise is created such that a difference in sound pressure level between the artificial noise and the background signal is at most 10 dB or at most 5 dB or at most 2 dB.

3. The method according to claim 1, wherein a desired signal is determined from the overall audio signal, and wherein a sound pressure level of the artificial noise is selected to be smaller than a sound pressure level of the desired signal.

4. The method according to claim 1, wherein the artificial noise is only added to the overall audio signal if a signal-to-noise ratio of the overall audio signal is between 3 dB and 15 dB.

5. The method according to claim 1, wherein
the sound pressure level of the artificial noise is continuously updated based on
the sound pressure level of the background signal.

6. The method according to claim 1, wherein
a speed of change of a sound pressure level of the artificial noise is limited to be below 1 dB/s or below 0.5 dB/s or below 0.1 dB/s.

7. The method according to claim 1, wherein the artificial noise is white noise or pink noise or grey noise or a frequency shaped version of the white, pink or grey noise.

8. The method according to claim 1, wherein the sound pressure level of at least one of the artificial noise and the background signal is determined as an average.

9. The method according to claim 8, wherein said average is a percentile of the overall audio signal level.

10. A hearing aid having a microphone, an output device, and a signal processing unit, and operated according to a method according to claim 1.

11. A method for operating a hearing aid system with two hearing aids according to claim 10, wherein the sound pressure level of the artificial noise in both hearing aids is matched to each other.
